(19) United States
(12) Patent Application Publication
(10) Pub. No.: US 2003/0233300 A1
(43) Pub. Date: Dec. 18, 2003

(54) Data management mechanism

(75) Inventors: Rauli Lento, Espoo (FI); Antti Koskelainen, Espoo (FI); Jukka Toivonen, Espoo (FI); Niko Nordlund, Bruxelles (BE)

Correspondence Address: OLIFF & BERRIDGE, PLC, P.O. BOX 19928, ALEXANDRIA, VA, 22320, US

(73) Assignee: FORTUM OYJ, Espoo (FI)

(21) Appl. No.: 10/166,698

(22) Filed: Jun. 12, 2002

(51) Int. Cl. G06F 17/60

(52) U.S. Cl. 705/36

(57) ABSTRACT

A method for managing a portfolio owned by several investors, the portfolio including products that permit, each, protecting the consumption of a given commodity at a given price and volume for a given period of time. In addition, the method defines each investor's share of the value of the portfolio such that the value of the portfolio is determined (1-2 . . . 1-12) on the basis of the delivery-period specific changes in value of the products and the value of the portfolio is divided (2-2 . . . 0.2-10) between the investors on the basis of the consumption reserved by each investor.

### BACKGROUND OF THE INVENTION

The invention relates to a mechanism for managing data, particularly in commodity funds. The commodity funds are funds, in which assets are invested in commodities, such as raw materials and/or energy, instead of stocks.

The operating principle of investment funds is simple. The fund management company pools investors' assets and invests them in a plurality of different companies, which constitute an investment fund. The fund is divided into fund units of equal size, having equal rights to the property in the fund. The fund is owned by its investors: natural persons, associations and foundations, so the portfolio management company does not own the investment funds it manages. How the investment funds operate is described in greater detail, for instance on the Internet at www.porssisaatio.fi

The basic principle of the investment funds is that the investor can continuously subscribe new fund units, and correspondingly, sell old fund units. Consequently, these investment funds are characteristically open. The opposite of open investment funds are closed investment funds that resemble conventional joint-stock companies.

A fund unit price is the same both for a new investor and one selling the unit, i.e. the current market value of the investments of the investment fund divided by the number of the fund units in circulation.

The investment fund has an advantage that the investor need not follow the events in the companies and on the markets as closely as would be the case if (s)he invested directly in stocks. Moreover, when assets are invested in an investment fund, the risk is distributed between several different investments, and consequently fluctuations are not so great as in investments in stocks of one sector.

However, the investment fund technology cannot be applied as such to commodity funds. For instance, one reason is complicated management, because commodities, as understood in connection with the present invention, are not sheer investments but they are used in manufacturing. A substantial problem with the commodities used in manufacturing is storage. The investment funds do not have this problem, or at least the storage costs are insignificant with respect to the value of the investment. The stocks are currently recorded and maintained in electronic form, and on the other hand, if the investment includes precious metals, they do not suffer from storage. Whereas, the commodity fund management of the present invention is complicated, for instance, because it is difficult or impossible to store the commodity. For instance, storage of hydroelectricity is limited by the size of water reservoirs. Likewise, oil or gas can be stored as much as the capacity of depots allows. Fruits and vegetables, in turn, must be consumed quickly or they perish.

What is common to the commodities in the fund of the claimed invention is that they have to be used at a given time, and therefore a delivery period and a volume (consumption) at said delivery period are generally advised in advance for them.

Another problem with the commodity funds is that small clients are not generally able to utilize the commodity funds, because commodities are not sold in so small batches that the small client could buy, sell or trade in said commodities. In this context, a small client refers to a client whose profit from the fund does not make it possible to employ a full-time portfolio manager. If fund units are divided between several small clients, a problem arises how the clients can join in the fund and withdraw from it.

### BRIEF DESCRIPTION OF THE INVENTION

A first object of the invention is to provide a mechanism, by which the above problems can be solved. Solving this problem involves certain information technology problems, and a second object of the invention is to solve these problems.

This is achieved with a method and an arrangement, which are characterized by what is disclosed in the independent claims. The preferred embodiments of the invention are disclosed in the dependent claims.

The invention is based on the fact that, for managing a portfolio owned by several investors, the portfolio including products that permit, each, protecting the consumption of a given commodity at a given price and volume, and at a given time each investor's share of the portfolio value is determined such that the value of the portfolio is determined on the basis of the changes in value per delivery period of the products and the value of the portfolio is divided between the investors based on the consumption protected by each investor.

The method and arrangement of the invention have an advantage that also a small client can utilize commodity funds and thus achieve the advantages the funds offer to their investors.

### BRIEF DESCRIPTION OF THE DRAWINGS

In the following, the invention will be described in greater detail in connection with the preferred embodiments, with reference to the attached drawings, wherein

FIG. 1 shows different states and information flows of a commodity fund portfolio;

FIG. 2A is a flow chart of client-specific changes in value and billing;

FIG. 2B shows changes in value and accrued value;

FIG. 2C shows changes in value and accrued value.

### DETAILED DESCRIPTION OF THE INVENTION

The invention is illustrated by using a concrete application, namely an electricity fund, whose commodities are electricity forwards, i.e. contracts on supplying electricity at a fixed price at a given future date. The electricity fund allows the investors to hedge against fluctuations in the price of electricity. Conventionally, electricity forwards of this kind have been available to major clients, but electricity suppliers have been reluctant to make this service available to small clients because of the high administration costs.

The electricity fund according to the invention operates such that the investor does not enter into a contract with the electricity supplier but the electricity fund. The electricity fund serves several small investors, and consequently the administration costs are divided between several investors. The investors draw up contracts formulated as follows: “I reserve an option to buy electricity a quantity of X at a price of Y during a delivery period N”. The delivery period is typically a given calendar month or a multiple thereof. The quantity is kilo- or megawatt hours and the price is naturally currency units (e.g. euros) per kilo- or megawatt hours. If the investor does not use the reserved quantity X in its entirety, he or she may sell the surplus to another investor. If the actual consumption exceeds the reserved quantity X, the investor either buys more electricity at a fixed price from other investors or pays for the extra quantity a current market price on delivery.

A few special terms are needed for understanding the operation of the electricity fund. First, a particular problem is, for instance, that the time period for which a given client wishes to buy a forward contract does not necessarily comply with any such period for which the electricity supplier wants to sell a forward contract. For instance, the client may wish to have a forward contract covering the period from October to December, but the portfolio manager has to buy several forward contracts and divide them between clients.

The portfolio includes products that permit, each, protecting the consumption of electricity at a given price and volume at a given time.

The delivery period is the time which the client wishes to cover by a forward contract. It is typically a given calendar month or a multiple thereof. For instance, a year can be divided into three or four seasons, each of which covers 3 to 4 months. A typical seasonal division in electricity contracts is winter 1 (from January to April), summer (from May to August) and winter 2 (from September to December).

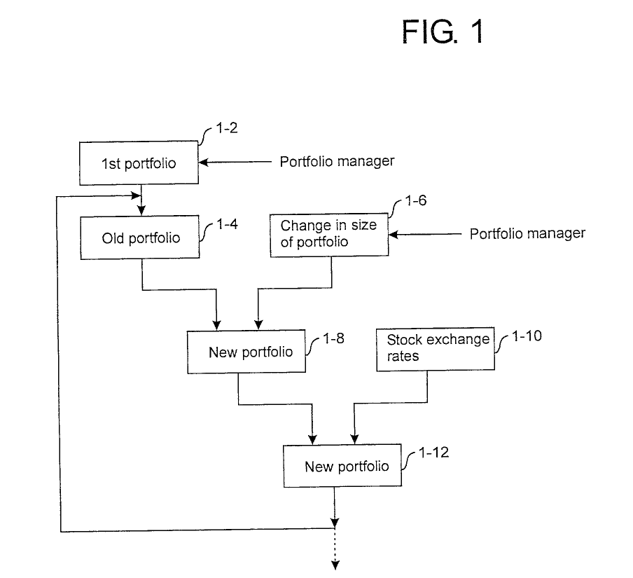

FIG. 1 shows different states and information flows of a commodity fund portfolio for determining transitions between the states. The state of the portfolio is determined by the number of the different products in the portfolio and the value of each product. At point 1-2, the value of the portfolio is determined for the first time, i.e. when the portfolio is established and one or more clients have joined in, and then it is possible to say that the investment portfolio is formed for the first time. Thereafter, said first investment portfolio can be transferred at point 1-4 to serve as an old portfolio.

At point 1-6, the portfolio manager buys and sells forward contracts. The portfolio manager buys forward contracts when a new investor joins in the fund or an old investor raises his protection. Buying and selling transactions may take place on the market, for instance, at a stock exchange. Because the size of the portfolio then changes, it is necessary to update the state of the portfolio at point 1-8. This can be performed such that the changes are catenated, i.e. attached to a previous portfolio at point 1-8.

Another factor that affects the state of the portfolio is changes in electricity prices, which are dealt with at point 1-10. The price changes are obtained from a commodity exchange, for instance. The portfolio is updated at point 1-12 such that for the existing portfolio products changes in value are calculated as price changes between the latest date and the day before. The date typically refers to a market day when the portfolio is updated such that a difference between the closing rates of the current market day and those of the preceding market day is calculated.

A new state of the portfolio having been formed, for instance after a market day, the portfolio can be transferred to serve as an old portfolio at point 1-4 and to await new operations and transactions, if any, of the next market day.

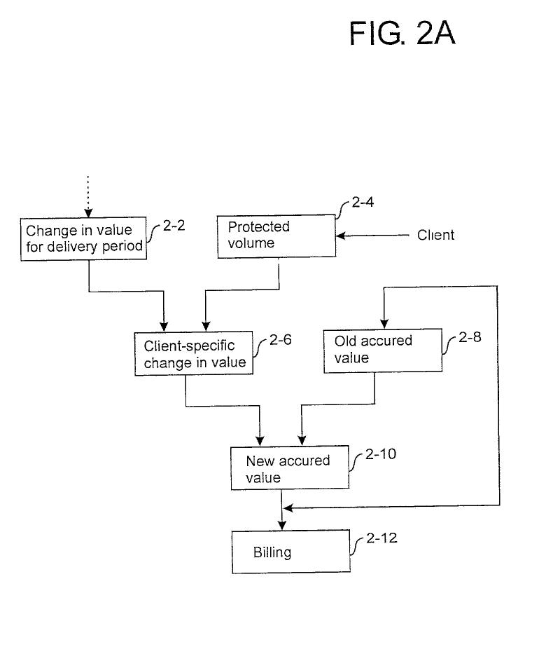

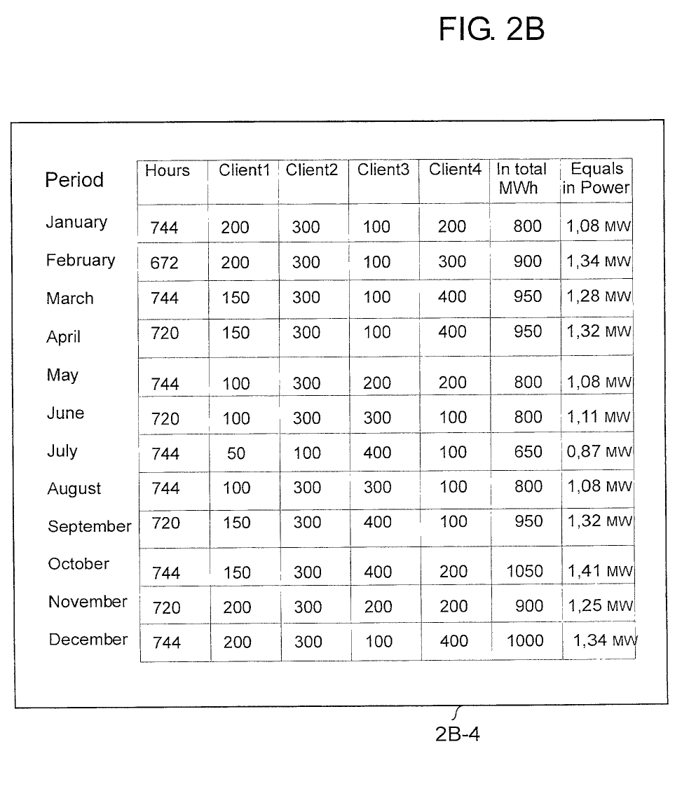

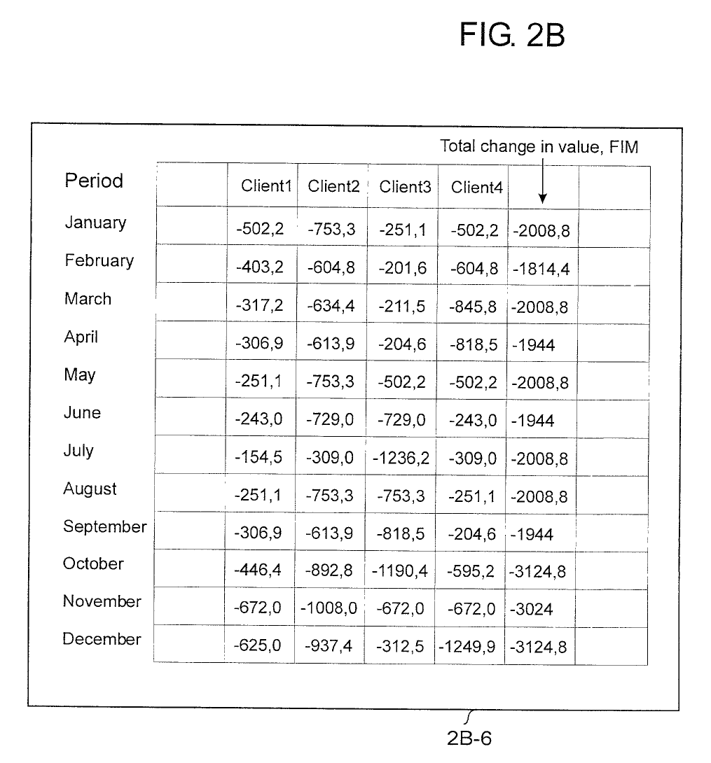

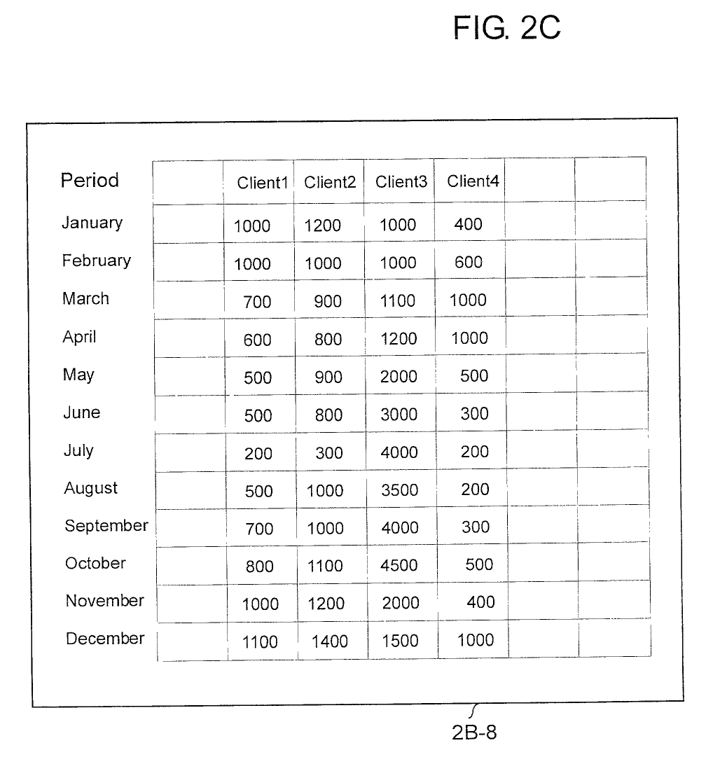

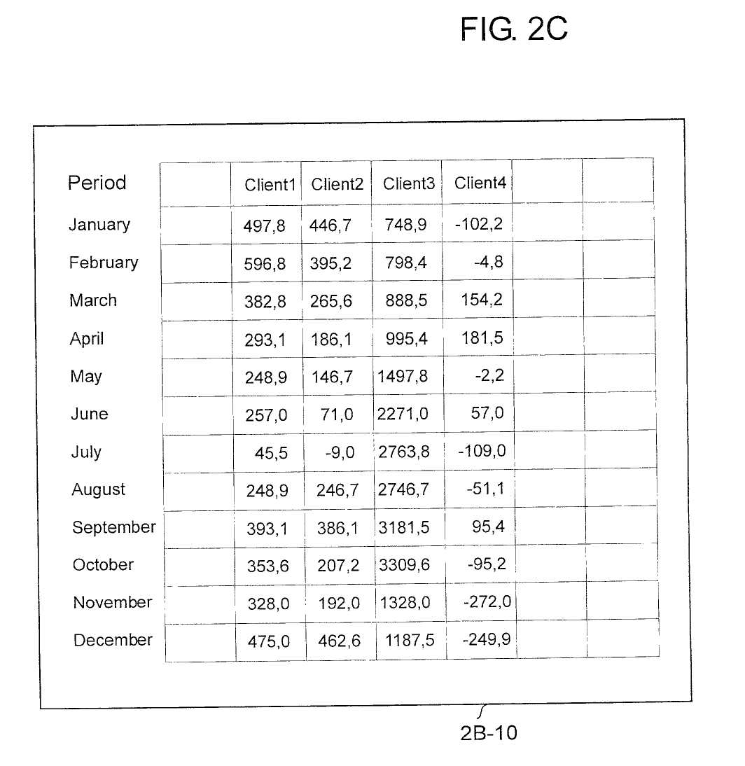

The operations shown in FIG. 1 enable the determination of the total value of the portfolio, but in connection with changes in the ownership of the portfolio (when new clients join in or old ones leave), the value of the portfolio has to be divided between the clients. This is shown in FIGS. 2A to 2C.

After calculating the changes in value for the products at the end of the market day, said changes in value can be distributed over the delivery periods of electricity. The distribution over the delivery periods can be carried out in a variety of ways. If the delivery period desired by the client coincides with just one period of time covered by a forward contract, it is possible to direct the product in its entirety to said delivery period. If the period of time covered by the forward contract overlaps a plurality of delivery periods, the product can be directed to different delivery periods, for instance, as hourly weighted averages. In this case, the product can be divided into percentages on the basis of how many hours each delivery period comprises.

The above-described division into delivery periods can take place at point 2-2 as in FIG. 2A. Because each product may cover a long period, i.e. it may include several delivery periods or parts thereof, each product can be divided into delivery periods. Each product can thus be divided into one-month periods, for instance.

On the basis of the volume reserved by the client at point 2-4, it is possible to calculate a client-specific change in value per delivery period at point 2-6. Said change in the value can also be referred to as accrued value, which can be summed up with the old accrued value stored at point 2-8, and thus a new accrued value will be obtained at point 2-10. The new accrued value can be transferred, restored to the old accrued value or forwarded for billing by delivery period or single performance.

Table 2B-4 of FIG. 2B shows the volume of electricity that the portfolio clients wish to reserve. For instance, for the period of January Client 1 wants to reserve consumption for 200 MWh, Client 2 for 300 MWh, Client 3 for 100 MWh and Client 4 for 200 MWh. In January the reserved quantity is thus 800 MWh in total. Corresponding reservation requirements have also been presented for other monthly periods. Table 2B-4 also shows hours per each month and a reservation need in megawatts (MW), which is obtained by dividing the summed up reservation need by the summed up hours in each month. For instance, the amount of 800 MWh to be reserved for January is divided by the hours for January 31*24=744 h, so the reservation need for January equals the (average) power of 1.08 MW. Even though the example relates to electricity, the same applies to any commodity that is required a given quantity per a given period of time.

Table 2B-6 presents the changes in value of the reservations in the portfolio at the end of the market day. For instance, for the January period the change in value is FIM −2,008.8, which amount divided by the clients' reservation needs is spread to clients 1, 2, 3 and 4 as follows: Client 1 has reserved consumption for 200 MWh/800 MWh (Table 2B-4), i.e. one quarter of the total consumption to be reserved. Thus, of the above-mentioned change in value for FIM −2,008.8, the amount of FIM −502.2 is allotted to Client 1. To Clients 2, 3 and 4 will be allotted the amounts of FIM −753.3, −251.1 and −502.2, respectively. In the similar manner, it is possible to calculate client-specific changes in value for all other periods as well.

Tables 2B-8 and 2B-10 of FIG. 2C illustrate old and new accrued values in a corresponding manner. For the sake of clarity, the final products of the calculations have been rounded such that the presentation can show whole numbers instead of decimal numbers.

Table 2B-8 shows a client- and period-specific portfolio with a calculated, accrued value, i.e. the sum of the changes in value, for the period when the client has owned a share in the fund. For instance, for the January period Clients 1, 2, 3 and 4 have accrued the amounts of FIM 1,000, FIM 1,200, FIM 1,000 and FIM 400, respectively.

The new accrued value 2B-10, i.e. distribution of the consumption to be reserved at a given moment for given periods will be obtained by summing up Tables 2B-6 and 2B-8. The obtained, new accrued value can be transferred into the old portfolio at 2-8 of FIG. 2A to await a next portfolio update at point 2-10.

The investors using electricity can thus express the desired quantity to be reserved as time series that will be summed up. The time series refers to a plurality of (successive, in general) delivery periods. In addition, the development of the fund value for each future period can be divided between the clients in proportion to their units, at predetermined intervals. Said changes in value can be stored client by client, whereby the following features can be provided, for instance:

division of accrued value for each period is independent;

if a new client joins in the fund, it does not affect the accrued value of other clients;

it is possible to change the time series given by the client within (?) the periods covered by the forward contracts;

the client can withdraw from the fund, if (s)he so desires, and the accrued profits/losses can be billed to the client without delay; and

the billing can be carried out on delivery.

Calculations and data controlling the operations by the portfolio manager, e.g. buying new commodities and selling commodities in the portfolio, may include data on expected values, reservation levels, open positions and risk and stress factors. The risk and stress factors can be calculated, for instance, by means of positions and price scenarios.

The yield from the fund according to the invention and the preferred embodiments thereof is based on profits from the investments made by the fund, i.e. for instance, interests, dividends and appreciation of investments. The owner of the fund unit can receive the net profits at a given, predetermined date, for instance.

Investment in a fund described by the invention and the preferred embodiments thereof also involves a risk. The risk includes a market risk, which means that it is not possible to know in advance how the market prices of the commodities in the portfolio develop. The quotations of the commodities may be higher or lower on the following day than on the day before.

However, one advantage of the invention and the preferred embodiments thereof is that a small client is now able himself to define, to some extent, an acceptable risk level. Namely, the client can define that the quantity of consumption to be reserved at a given price is the quantity he expects to need at a given future date, for instance during period 4 (for instance) in April.

The invention and the preferred embodiments thereof also allow the small investor to trade at lower costs and to use expert advice. The experts follow the development of the commodity markets and the funds they manage on a continuous basis and adjust the investments according to the market situation, if necessary.

Thanks to the invention, it is now possible for a small investor to join in or withdraw from the fund at all times, even though the delivery periods of various investors do not fully match with the periods covered by the forward contracts. For instance, if the commodity concerned is electricity and the instrument is a fixed-priced forward contract, the buyer and seller of the commodity can agree, prior to the actual delivery period, on the delivery of electricity at a fixed basic price, which would be the object of the clients' competition. It is typical to the fixed-price contract, by which buying and selling is agreed upon at a fixed, predetermined price, that it is of random size and not standardized.

Thanks to the invention, the small investor can protect consumption, for instance, 10%, 50% or 100%. Consumption can be protected with a portfolio, whose operating principles and risk policy (s)he has accepted. The client may distribute the reservation need to more than one portfolios. Thus, the client can protect the consumption, for instance, 30% with a low-risk portfolio, 20% with a medium-risk portfolio and 50% with a high-risk portfolio. In addition, the investment report sent to the client may also give report, among other feedback, on the risk situation of the client's reservation.

The commodity fund according to the invention can be applied to all financial and physical contracts. These include buying and selling options, swap instruments, futures and forward instruments. The fund can be used for managing all commodities. These may include raw materials or foodstuffs, and energy commodities, such as electricity, oil and gas.

The present invention can be embodied as computer software in any computation system including processing and storage capacity required. The computation system may be accessible over data network, so that a client investor can perform investment transactions and obtain the reports or view the reports online from a remote workstation. The client user-interface may be embodied as a website (e.g. World Wide Web) which is accessible over the Internet from a workstation using web browser.

It is apparent to a person skilled in the art that as technology progresses the basic idea of the invention can be implemented in a variety of ways. Thus, the invention and the embodiments thereof are not restricted to the above-described examples, but they may vary within the scope of the claims.

1. A method for managing a portfolio owned by several investors, comprising:
the portfolio including products that permit, each, protecting the consumption of a given commodity at a given price and volume at a given time;
determining each investor's share of the value of the portfolio by
i) determining the value of the portfolio on the basis of the changes in value per delivery period of the products; and
ii) dividing the value of the portfolio between the investors on the basis of the consumption protected by each investor.

2. The method of claim 1, for managing the portfolio, comprising:
maintaining information on the state of the portfolio at a first date, the state of the first date including information on at least the products, product prices and volumes;
producing information on the state of the portfolio at a second date at least on the basis of the information provided by the state of the portfolio at the first date and by the market and/or the information provided by the portfolio manager, the state of the portfolio at the second date including information on changes in value of the portfolio products, and the information provided by the market including information on the closing rates of the portfolio products, and the information provided by the portfolio manager including information on new products in the portfolio, product prices and volumes; and
replacing the state of the portfolio at the first date with the state of the portfolio at the second date generated in the preceding step.

3. The method of claim 2, wherein the information on the changes in value of the portfolio products at the second date are calculated by multiplying the changes in the product prices by the volume, the changes being obtained as differences of the commodity prices of the second and first dates.

4. The method of claim 1, wherein the changes in value of the commodities are distributed to the delivery periods for generating the changes in value for the delivery periods.

5. The method of claim 1, wherein the client-specific change in value is generated at least on the basis of the period-specific reserved volume defined by the client.

6. The method of claim 5, wherein the client-specific change in value is generated by dividing the period-specific reserved volume defined by one client by the sum of the period-specific reserved volumes defined by all clients, the product of which computing operation is multiplied by the change in value of the delivery period.

7. The method of claim 2, wherein the commodity is electricity.

8. A method for managing a portfolio owned by several investors, comprising:
the portfolio including products that permit, each, protecting the consumption of a given commodity at a given price and volume at a given time,
maintaining information on the state of the portfolio at a first date, the state of the first date including information on at least the products, product prices and volumes;
producing information on the state of the portfolio at a second date at least on the basis of the information provided by the state of the portfolio at the first date and by the market and/or the information provided by the portfolio manager, the state of the portfolio at the second date including information on changes in value of the portfolio products, and the information provided by the market including information on the closing rates of the portfolio products, and the information provided by the portfolio manager including information on new products in the portfolio, product prices and volumes; and
replacing the state of the portfolio at the first date with the state of the portfolio at the second date generated in the preceding step, and
determining each investor's share of the value of the portfolio by
i) determining the value of the portfolio on the basis of the changes in value per delivery period of the products; and
ii) dividing the value of the portfolio between the investors on the basis of the consumption protected by each investor.
